(19) United States
(12) Patent Application Publication
(10) Pub. No.: US 2022/0033562 A1
(43) Pub. Date: Feb. 3, 2022

(54) WATER-DISPERSIBLE POLYURETHANE-UREA RESIN COMPOSITION FOR SYNTHETIC LEATHER AND PREPARING METHOD THEREOF

(71) Applicant: DONGSUNG CHEMICAL Co., Ltd., Busan (KR)

(72) Inventors: Taeung KIM, Busan (KR); Jooil KIM, Busan (KR); Dohoon KIM, Busan (KR); Jongsub SHIN, Busan (KR); Yongdeuk KWON, Busan (KR)

(21) Appl. No.: 17/391,386

(22) Filed: Aug. 2, 2021

(30) Foreign Application Priority Data
Aug. 3, 2020 (KR) 10-2020-0096801

(51) Int. Cl. C08G 18/10; C08G 18/32; C08K 5/42; C08G 18/42; C08G 18/08; D06N 3/14

(52) U.S. Cl. CPC C08G 18/10; C08G 18/3206; C08K 5/42; C08G 18/4238; C08K 2201/005; C08G 18/0866; D06N 3/147; D06N 2211/28; C08G 18/0828

(57) ABSTRACT

The present disclosure relates to a polyurethane-urea resin composition for synthetic leather and a method of preparing the polyurethane-urea resin composition, the polyurethane-urea resin composition having excellent resin stability, heat resistance and aesthetic properties by including an ionic compound containing a sulfonic acid group, and by not including a neutralizer. In addition, the polyurethane-urea resin composition for synthetic leather may be applicable for various purposes by controlling a polyurethane-urea particle size to a desired size by controlling a content of the ionic compound containing a sulfonic acid group.

### CROSS-REFERENCE TO RELATED APPLICATION

This application claims priority under 35 U.S.C. § 119 to Korean Patent Application No. 10-2020-0096801, filed on Aug. 3, 2020, in the Korean Intellectual Property Office (KIPO), the disclosure of which is incorporated by reference herein in its entirety.

### TECHNICAL FIELD

The present disclosure relates to a water-dispersible polyurethane-urea resin composition for synthetic leather, and more particularly, to a polyurethane-urea resin composition for synthetic leather having excellent resin stability by including an ionic compound containing a sulfonic acid group, instead of a carboxylic acid-based ionic compound, and by not including a neutralizer, and to a method of preparing the same.

### BACKGROUND ART

As an alternative to conventional solvent-type resins which may cause environmental problems because of various organic solvents used therein, water-dispersible polyurethane-urea resins are being developed. In particular, the regulation of organic solvents is gradually increasing to prevent harm to the human body caused by the use of organic solvents during the production process of the solvent-type resins, and accordingly, solvent-free polyurethane or water-dispersible polyurethane-urea resins and the like are being developed.

In preparing of the water-dispersible polyurethane-urea resin, an ionic compound may be used to disperse a hydrophobic prepolymer in water. Conventionally, a carboxylic acid salt has been used as such an ionic compound, and in this case, a neutralizer has also been used together. Since a material such as triethylamine which is used as a neutralizer promotes hydrolysis of polyester polyol, which is a component of the prepolymer, there is a problem in that polyols that may be used for preparing the polyurethane-urea resin are limited and the resin stability is poor.

According to Korean Patent Publication No. 10-2011-0029111, a method of preparing an aqueous polyurethane-urea dispersion has been proposed in which dimethylolpropionic acid was mainly used as an ionic compound to disperse a prepolymer in water, and triethylamine was additionally used to improve dispersibility of the prepolymer.

In addition, physical properties of an aqueous polyurethane dispersion according to an amount of an ionic compound having a carboxylic acid group and a sulfonic acid group is disclosed in the paper [H. Honarkar, M. Barmar*, and M. Barikani, Fibers and Polymers 2015, Vol. 16, No. 4, 718-725]. However, in the case of using polyol and isocyanate used in the above paper, the product cost is high, and the physical properties of the prepared aqueous polyurethane dispersion are not suitable for use as polyurethane for synthetic leather.

### SUMMARY

Aspects of embodiments of the present disclosure are directed to a polyurethane-urea resin composition for synthetic leather having excellent resin stability, heat resistance and aesthetic properties by including an ionic compound containing a sulfonic acid group, instead of a conventional carboxylic acid salt as a component of the water-dispersible polyurethane-urea resin composition for synthetic leather, and by not including a neutralizer, and to a method of preparing the same.

Aspects of embodiments of the present disclosure are also directed to a polyurethane-urea resin composition for synthetic leather applicable to various materials by controlling a content of an ionic compound including a sulfonic acid group to control a polyurethane-urea particle size, and to a method of preparing the same.

According to an embodiment of the present disclosure, a water-dispersible polyurethane-urea resin composition for synthetic leather includes: a polyol including a polyester polyol, a polyether polyol or a mixture thereof; an isocyanate; and an ionic compound including a sulfonic acid group.

According to another embodiment of the present disclosure, a method of preparing a water-dispersible polyurethane-urea resin composition for synthetic leather is provided.

### BRIEF DESCRIPTION OF THE DRAWINGS

FIG. 1 illustrates size distribution of polyurethane-urea particles according to Embodiment 1.

### DETAILED DESCRIPTION

Hereinafter, the inventive concept of the present disclosure will be described.

It is to be understood that all terms (including technical and scientific terms) used in the present disclosure have meanings generally understood by those of ordinary skill in the technical field to which the present disclosure belongs, unless otherwise defined. All terms used in the present disclosure are selected for the purpose of more clearly describing the present disclosure and are not selected to limit the scope of the present disclosure. In addition, terms defined in a commonly used dictionary are not to be interpreted ideally or excessively unless clearly defined.

<Water-Dispersible Polyurethane-Urea Resin Composition for Synthetic Leather>

Conventionally, when preparing a polyurethane-urea resin composition, a compound including a carboxylic acid salt, such as dimethylol propionic acid or dimethylol butanoic acid, has been used to disperse a hydrophobic prepolymer in water, and a neutralizer (e.g., neutralizing agent) has been further added to improve dispersibility of the prepolymer. When polyester polyol is used in the polyurethane-urea resin composition, excellent effects may be expected not only in physical properties such as adhesion, but also in surface touch feeling and aesthetic properties such as surface color. However, since the neutralizer acts as a hydrolysis accelerator of the polyester polyol, there is a limit in applying the polyester polyol when using a compound including the carboxylic acid salt, and there is a problem in that the resin stability is degraded by adding the neutralizer.

A water-dispersible (e.g., water-dispersed) polyurethane-urea resin composition for synthetic leather according to the present disclosure is differentiated from the conventional polyurethane-urea resin composition for synthetic leather in that it includes an ionic compound containing a sulfonic acid group, instead of a carboxylic acid salt, and does not include a neutralizer. Specifically, the composition may achieve both excellent resin stability and excellent aesthetic properties by including a polyol which includes a polyester polyol, a polyether polyol, or a mixture thereof, an isocyanate, and an ionic compound which includes a sulfonic acid group, and by not including a neutralizer.

The water-dispersible polyurethane-urea resin composition for synthetic leather according to the present disclosure includes an ionic compound including a sulfonic acid group.

The ionic compound including a sulfonic acid group serves to impart a hydrophilic group to a prepolymer prepared by reacting the polyol with the isocyanate.

A content of the ionic compound including a sulfonic acid group may be in a range of 1 to 15 parts by weight, more preferably 3 to 10 parts by weight, with respect to the total weight (e.g., 100 parts by weight) of the polyol. The ionic compound including a sulfonic acid group may include, for example, sodium-N-(2-aminoethyl)aminoethanesulfonate, sodium-3-[(2-aminoethyl)amino]propanesulfone, sodium-2-[(2-aminoethyl)amino]ethanesulfonate or mixtures thereof.

The water-dispersible polyurethane-urea resin composition for synthetic leather according to the present disclosure may not include a neutralizer.

Conventionally, a neutralizer was used to disperse a hydrophobic prepolymer in water when preparing a polyurethane-urea resin composition, but in the present disclosure, the ionic compound including a sulfonic acid group instead of a carboxylic acid salt is used, and accordingly, the prepolymer may be dispersed in water although a neutralizer is not included.

The neutralizer may include all conventional neutralizers known in the art, for example, one or more of ammonia, ammonium carbonate or ammonium bicarbonate, trimethylamine, triethylamine, tributylamine, diisopropylethylamine, dimethylethanolamine, diethylethanolamine, triethanolamine, potassium hydroxide or sodium carbonate, and specifically, may be triethylamine, triethanolamine, dimethylethanolamine or diisopropylethylamine, or a mixture thereof.

The polyol constituting the water-dispersible polyurethane-urea resin composition for synthetic leather according to the present disclosure may include a polyester polyol, a polyether polyol, or a mixture thereof, and specifically, may include both the polyester polyol and the polyether polyol.

The polyol is a substance constituting a soft segment of the water-dispersible polyurethane-urea resin. In the present disclosure, by applying the polyester polyol as a component of the polyol, it is possible to improve aesthetic properties such as surface touch feeling of a formed body, skin toner compatibility, and the like.

The polyester polyol may include, for example, one or more polyols of polyethylene butylene adipate glycol, polyethylene adipate glycol, polybutylene adipate glycol, polyhexamethylene adipate glycol, and polycaprolactone glycol.

In addition, the polyether polyol may include, for example, one or more polyols of polytetramethylene glycol, polyethylene glycol, polypropylene glycol, and polyoxypropylene ether glycol.

In order to prepare a formed body having excellent mechanical properties, a weight average molecular weight of the polyester polyol and the polyether polyol may be in a range of 1,000 to 4,000, and more specifically, in a range of 1,500 to 2,500.

In addition, the polyol according to the present disclosure may include a common diol-based polyol known in the art. The applicable diol-based polyol may include, for example, one or more polyols of ethylene glycol, 1,4-butane diol, 1,6-hexane diol, and 1,3-propane diol.

Considering physical properties of a synthetic leather skin to be prepared, a content of the polyol may be in a range of 15 to 25 parts by weight, preferably in a range of 18 to 23 parts by weight, with respect to the total weight (e.g., 100 parts by weight) of the polyurethane-urea resin composition. When the content of the polyol is less than 15 parts by weight, a degree of curing of the synthetic leather skin may increase and the physical properties may be degraded, and when it exceeds 25 parts by weight, softness of the synthetic leather skin increases, which may cause a problem in applying it as a skin.

A mixing ratio of the polyester polyol and the polyether polyol may be in a range of 1:0.25 to 2 by weight.

In addition, an isocyanate compound is included as another component constituting the prepolymer of the present disclosure. The isocyanate is a material that reacts with the polyol to synthesize a urethane group and constitutes a hard segment.

The isocyanate may include, for example, an aliphatic isocyanate, an aromatic isocyanate, or a mixture thereof, and a mixing ratio of the aliphatic isocyanate and the aromatic isocyanate may be in a range of 1:0.5 to 2 by weight.

Non-limiting examples of the applicable isocyanate may include, for example, dicyclohexylmethane diisocyanate, isophorone diisocyanate, 1,6-hexamethylene diisocyanate, 2,4-toluene diisocyanate, 2,6-toluene diisocyanate, 4,4′-diphenylmethane diisocyanate, 1,5-naphthalene diisocyanate, p-phenylene diisocyanate, m-phenylene diisocyanate, hexamethylene diisocyanate trimer, 4,4′-dicyclohexylmethane diisocyanate, 4,4-dimethylphenylmethane diisocyanate, bis-4-(isocyanate cyclohexyl)methane, polymeric methylene diphenyl diisocyanate, xylene diisocyanate, lysine diisocyanate, tolidine diisocyanate, tetra methylene diisocyanate, trans-1,4-cyclohexane diisocyanate, tetramethyl-1,3-xylene diisocyanate, isophorone diisocyanate, dimethyl diisocyanate, 1,1,6,6,-tetrahydrofluoro-hexamethylene diisocyanate, trimethyl hexamethylene diisocyanate, dimethyl diphenyl diisocyanate, triphenyl methane triisocyanate or a mixture thereof.

In addition, a content of the isocyanate may be preferably in a range of 20 to 70 parts by weight, more preferably 30 to 60 parts by weight, with respect to the total weight of the polyol. When the content of the isocyanate is less than 20 parts by weight, strength of the synthetic leather skin may decrease, and when it exceeds 70 parts by weight, stability and physical properties of the polymer may be degraded because side reactions may occur due to the rapid reaction.

In addition, according to the present disclosure, a chain extender may be further included as a component forming the resin. By using such a chain extender, intermolecular bonds may be strengthened.

The chain extender may be a diamine-based or diol-based chain extender. The applicable chain extender may include, for example, one or more of isophorone diamine, ethylene diamine, diethylene triamine, triethylene tetraamine, dicyclohexylmethylene diamine, 1,6-hexamethylene diamine or piperazine, ethylene glycol, diethylene glycol, triethylene glycol, propylene glycol, dipropylene glycol, butylene glycol, 1,3-butanediol, 1,4-butanediol, 2-methylpentanediol, 1,5-pentanediol, 1,6-hexanediol, hexylene glycol, neopentyl glycol, 4-cyclohexanedimethanol, trimethylol propane, and pentaerythritol.

A content of the chain extender may be in a range of 2 to 15 parts by weight with respect to the total weight of the polyol, but the present disclosure is not particularly limited thereto.

In addition, the water-dispersible polyurethane-urea resin composition for synthetic leather of the present disclosure may use a catalyst or the like, if necessary. The catalyst may be added at any stage of the reaction. However, its addition amount is also not particularly limited.

The catalyst may include, for example, one or more of various metal salts represented by, for example, potassium acetate, zinc stearate, tin octylate, and the like, and various organometallic compounds represented by, for example, dibutyltin dilaurate, and the like.

In addition, since the water-dispersible polyurethane-urea resin composition for synthetic leather of the present disclosure does not include a neutralizer, it has excellent resin stability, and specifically, layer separation may not occur when stored at 70° C. for 14 days or more.

<Method of Preparing Water-Dispersible Polyurethane-Urea Resin Composition for Synthetic Leather>

Hereinafter, a preparing method according to an embodiment of the present disclosure will be described. However, embodiments of the present disclosure are not limited by the following preparing method, and steps of each process may be modified or selectively mixed as needed.

The water-dispersible polyurethane-urea resin composition for synthetic leather of the present disclosure may be prepared by: preparing a prepolymer by reacting a polyol including a polyester polyol, a polyether polyol, or a mixture thereof with an isocyanate; preparing a composition by adding a polar solvent to the prepolymer and then adding an ionic compound including a sulfonic acid group; and adding water to the composition to disperse the composition and then mixing a chain extender thereto.

First, a prepolymer is prepared by reacting a polyol including a polyester polyol, a polyether polyol, or a mixture thereof with an isocyanate. In such a case, a mixing ratio of the polyol and the isocyanate may be in a range of 1:0.2 to 0.8 by weight.

In such a case, termination of the prepolymer reaction is based on when an NCO content of the isocyanate by titration is lowered below a theoretical value and there is no change.

Next, a polar solvent is added to the prepolymer, and then an ionic compound including a sulfonic acid group is added thereto to prepare a composition.

The polar solvent used in the present disclosure is not particularly limited as long as it is a solvent commonly used in the art, and any solvent capable of dispersing the prepolymer and easy to be removed during extraction may be applicable.

A content of the polar solvent may be in a range of 50 to 200 parts by weight with respect to the total weight of the polymer depending on the use of the polyurethane-urea resin, and the polar solvent may be added at any stage such as at the beginning of the reaction, during the reaction, or at the end of the reaction.

The ionic compound including a sulfonic acid group is as described above. While carboxylic acid salts such as dimethylol propionic acid and dimethylol butanoic acid are used in the step of preparing the prepolymer, the ionic compound having a functional group of amine and a sulfonic acid group may preferably be used after the prepolymer reaction.

A content of the ionic compound including a sulfonic acid group may be in a range of 1 to 15 parts by weight, more preferably 3 to 10 parts by weight, with respect to the total weight of the polyol. In such a case, by adjusting the content of the ionic compound including a sulfonic acid group, a size of polyurethane-urea particles included in the polyurethane-urea resin composition may be controlled freely.

Next, water is added to the composition to disperse the composition, thereby preparing a water-dispersible (e.g., water-dispersed) dispersion, and a chain extender is mixed thereto. After mixing the chain extender, the polar solvent is removed, and a polyurethane-urea resin composition for synthetic leather is thereby prepared.

In the water-dispersible polyurethane-urea resin composition for synthetic leather prepared according to the above preparing method, the size of the polyurethane-urea particles dispersed in water may be in a range of 500 to 1500 nm.

Hereinafter, the present disclosure will be described in more detail through embodiments. However, the following embodiments are only for illustrating the present disclosure, and the scope of the present disclosure is not limited to the embodiments.

### Embodiment 1

1-1. Synthesis of Prepolymer

83.4 g of polyethylene adipate glycol (Mw 2,500), 6 g of 1,4-butanediol (Mw 90.12), and 66.7 g of polytetramethylene glycol (Mw 2,000) were added to a 4-neck flask equipped with a stirrer, a thermometer, and a condenser, and then were stirred at 60° C. for 30 minutes. Then, under the same conditions, 32.6 g of isophorone diisocyanate was added, 30 g of 4,4-methylene diphenyl diisocyanate was then added, and the reaction was performed at 90 to 100° C. for 4 hours to synthesize a prepolymer. 295.8 g of acetone was added to dissolve the prepolymer, and termination of the prepolymer reaction was based on when an NCO content by titration was lowered below a theoretical value and there was no change.

1-2. Preparation of Water-Dispersible Polyurethane-Urea Resin Composition for Synthetic Leather

After dissolving the prepolymer in acetone, the temperature inside the flask was adjusted to 40° C. or less, and 9.8 g of sodium-N-(2-aminoethyl)aminoethanesulfonate (Mw 190.19) (3.97% based on solid content) was added in portions for 20 minutes. After 60 minutes, 457.8 g of water was slowly added and water-dispersion was carried out through high-speed stirring. Next, 13.6 g of isophorone diamine (Mw 170.25) mixed in water was added dropwise thereto over 3 times for 10 minutes, and after stirring for an additional hour, the reaction was terminated. The termination point was based on disappearance of an NCO peak by applying FT-IR. After completion of the reaction, the acetone was removed by vacuum.

### Embodiment 2

2-1. Synthesis of Prepolymer

84.2 g of polyethylene adipate glycol (Mw 2,500), 6.1 g of 1,4-butanediol (Mw 90.12), and 67.3 g of polytetramethylene glycol (Mw 2,000) were added to a 4-neck flask equipped with a stirrer, a thermometer, and a condenser, and then were stirred at 60° C. for 30 minutes. Then, under the same conditions, 32.9 g of isophorone diisocyanate was added, 30.3 g of 4,4-methylene diphenyl diisocyanate was then added, and the reaction was performed at 90 to 100° C. for 4 hours to synthesize a prepolymer. 295.8 g of acetone was added to dissolve the prepolymer, and termination of the prepolymer reaction was based on when an NCO content by titration was lowered below a theoretical value and there was no change.

2-2. Preparation of Water-Dispersible Polyurethane-Urea Resin Composition for Synthetic Leather

A water-dispersible polyurethane-urea resin composition for synthetic leather was prepared in the same manner as in Embodiment 1-2, except that 8.3 g of sodium-N-(2-aminoethyl)aminoethanesulfonate (Mw 190.19) (3.37% based on solid content) was used.

### Embodiment 3

3-1. Synthesis of Prepolymer

82.7 g of polyethylene adipate glycol (Mw 2,500), 6 g of 1,4-butanediol (Mw 90.12), and 66.1 g of polytetramethylene glycol (Mw 2,000) were added to a 4-neck flask equipped with a stirrer, a thermometer, and a condenser, and then were stirred at 60° C. for 30 minutes. Then, under the same conditions, 32.3 g of isophorone diisocyanate was added, 29.8 g of 4,4-methylene diphenyl diisocyanate was then added, and the reaction was performed at 90 to 100° C. for 4 hours to synthesize a prepolymer. 295.8 g of acetone was added to dissolve the prepolymer, and termination of the prepolymer reaction was based on when an NCO content by titration was lowered below a theoretical value and there was no change.

3-2. Preparation of Water-Dispersible Polyurethane-Urea Resin Composition for Synthetic Leather

A water-dispersible polyurethane-urea resin composition for synthetic leather was prepared in the same manner as in Embodiment 1-2, except that 11.3 g of sodium-N-(2-aminoethyl)aminoethanesulfonate (Mw 190.19) (4.57% based on solid content) was used.

### Embodiment 4

Synthesis was carried out under the same method and conditions as in Embodiment 1, and a water-dispersible polyurethane urea for synthetic leather was prepared in a commercial production system by using a prepared water-dispersible polyurethane-urea resin composition for synthetic leather. The prepolymer reaction and acetone addition were carried out in a primary reactor using an anchor-type stirrer. Then, the acetone added prepolymer was transferred to a secondary reactor to prepare a water-dispersible polyurethane-urea resin composition for synthetic leather, and a disk-type stirrer was used. After completion of the reaction in the secondary reactor, acetone was removed by vacuum.

### Comparative Example 1

1-1. Synthesis of Prepolymer

82.3 g of polyethylene adipate glycol (Mw 2,500), 5.9 g of 1,4-butanediol (Mw 90.12), 65.9 g of polytetramethylene glycol (Mw 2,000), and 9.72 g of dimethylol butonic acid (Mw 148.18) (3.94% based on solid content) were added to a 4-neck flask equipped with a stirrer, a thermometer, and a condenser, and then were stirred at 90 to 95° C. for 1 hour. Then, under the same conditions, 32.2 g of isophorone diisocyanate was added, 29.7 g of 4,4′-methylene diphenyl diisocyanate was then added, and the reaction was performed at 90 to 100° C. for 4 hours to synthesize a prepolymer. 295.8 g of acetone was added to dissolve the prepolymer, and termination of the prepolymer reaction was based on when an NCO content by titration was lowered below a theoretical value and there was no change.

1-2. Preparation of Water-Dispersible Polyurethane-Urea Resin Composition for Synthetic Leather

After dissolving the prepolymer in acetone, the temperature inside the flask was adjusted to 40° C. or less, and 7.3 g of triethylamine was added thereto to carry out a neutralization reaction for 20 minutes. Then, water-dispersion was carried out through high-speed stirring while gradually adding 457 g of water. Next, isophorone diamine (Mw 170.25) mixed in water was added dropwise thereto over 3 times for 10 minutes, and after stirring for an additional hour, the reaction was terminated. The termination point was based on disappearance of an NCO peak by applying FT-IR. After completion of the reaction, the acetone was removed by vacuum.

### <Evaluation Example 1> Evaluation of Physical Properties of Water-Dispersible Polyurethane-Urea Resin Composition for Synthetic Leather

Physical properties of the water-dispersible polyurethane-urea resin composition for synthetic leather prepared in Embodiments 1 to 4 and Comparative Example 1 were evaluated as follows.

1) Particle size: Particle size analyzer (Zetasizer Nano ZS)

2) Softening point: KS M 6634 method

3) 100% modulus: ASTM D638 method

4) Adhesion: KS MSOI36

5) Resin stability: when layer separation or precipitation occurs after a resin stock solution (e.g., undiluted solution) was stored at 70° C.

TABLE 1

| | Embodi- | Embodi- | Embodi- | Embodi- | Comp. |
|---|---|---|---|---|---|
| | ment 1 | ment 2 | ment 3 | ment 4 | Ex. 1 |
| Particle | 888 | 1030 | 724 | 800 | 115 |
| size (nm) | | | | | |
| Softening | 165 | 167 | 164 | 167 | 162 |
| point (° C.) | | | | | |
| 100% Modulus | 28 | 26 | 29 | 29 | 27 |
| (kgf/cm²) | | | | | |
| Adhesion | 3.5~4.5 | 3.5~4.5 | 3.5~4.5 | 3.5~4.5 | 3.5~4.5 |
| (kgf/inch) | | | | | |
| Resin | 14 days or | 14 days or | 14 days or | 14 days or | 7 days |
| stability | more | more | more | more | |

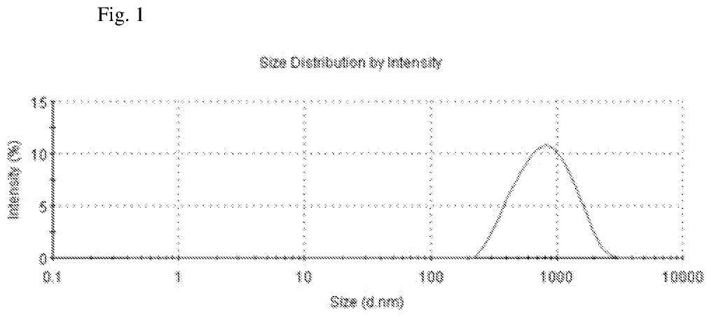

1) Particle size: the results of particle size analysis according to the content of the ionic compound including a sulfonic acid group are shown. As the content of the ionic compound including a sulfonic acid group increased, the size of the polyurethane-urea particle decreased because a content of an anionic hydrophilic group increased. (Embodiments 1 to 4) In Comparative Example 1, a carboxylic acid salt was used instead of the ionic compound including a sulfonic acid group, and the particle size is less than those of Embodiments 1 to 4, which is presumed to be a result of a difference in activity and reactivity of the hydrophilic group between the ionic compound including a sulfonic acid group and the carboxylic acid salt. FIG. 1 shows the results of particle size analysis of polyurethane-urea according to Embodiment 1.

2) Softening point, 100% Modulus: the results of the physical properties of a polyurethane-urea film are shown. Even when the ionic compound including a sulfonic acid group instead of a carboxylic acid salt was used, there was no significant difference in physical properties such as heat resistance and 100% modulus. Based on this, it may be appreciated that the physical property values are shown by the polyol, the isocyanate and the chain extender, and the ionic compound including a sulfonic acid group affects dispersibility and stability of the composition.

The film used for measurement was prepared by applying the polyurethane-urea resin to a thickness of 0.2 mm, drying at 110° C. for 2 minutes, and aging at 70° C. for 12 hours.

3) Adhesion: After fabricating a synthetic leather skin, a surface adhesion with a seam sealing tape was identified, and excellent results were confirmed for all resins in terms of adhesion due to the application of polyester polyol.

The synthetic leather skin applied when measuring the adhesion (e.g., adhesive force) was prepared by applying a toner-blended polyurethane-urea resin to a thickness of 0.15 mm and then drying the skin at 110° C. for 2 minutes twice. Then, the adhesion was measured using a specimen in which a backing layer was laminated after binder coating on the top of the skin.

4) Resin stability: the stability of the water-dispersible polyurethane-urea resin for synthetic leather was evaluated at 70° C. Embodiments 1 to 4 have stability for 14 days or more. In Comparative Example 1, layer separation occurred when 7 days had elapsed, which is considered to be due to triethylamine applied as a neutralizer.

As shown in Table 1, the water-dispersible polyurethane-urea resin composition for synthetic leather including an ionic compound which contains a sulfonic acid group has excellent stability, and the film prepared using the same shows excellent physical properties. In addition, in Embodiment 4, it was appreciated that the polyurethane-urea resin composition for synthetic leather according to the present disclosure may be prepared and manufactured in a commercialized production system. In addition, the water-dispersible polyurethane resin compositions for synthetic leather according to Embodiments 1 to 4 were improved in terms of aesthetic properties such as surface touch feeling and skin toner compatibility because it used polyester polyol and did not include any neutralizer.

As set forth hereinabove, according to one or more embodiments of the present disclosure, a water-dispersible polyurethane-urea resin composition for synthetic leather has excellent resin stability, heat resistance and aesthetic properties by including an ionic compound containing a sulfonic acid group, instead of a conventional carboxylic acid salt as a component of the resin composition, and by not including a neutralizer.

In addition, according to one or more embodiments of the present disclosure, the water-dispersible polyurethane-urea resin composition for synthetic leather may be controlled in terms of a polyurethane-urea particle size by controlling a content of an ionic compound including a sulfonic acid group.

What is claimed is:

1. A water-dispersible polyurethane-urea resin composition for synthetic leather, comprising:
a polyol comprising a polyester polyol, a polyether polyol or a mixture thereof;
an isocyanate; and
an ionic compound comprising a sulfonic acid group.

2. The water-dispersible polyurethane-urea resin composition for synthetic leather of claim 1, wherein the composition does not contain a neutralizer.

3. The water-dispersible polyurethane-urea resin composition for synthetic leather of claim 1, wherein a content of the ionic compound comprising the sulfonic acid group is in a range of 1 to 15 parts by weight with respect to the total weight of the polyol.

4. The water-dispersible polyurethane-urea resin composition for synthetic leather of claim 1, wherein the ionic compound comprising the sulfonic acid group comprises sodium-N-(2-aminoethyl)aminoethanesulfonate, sodium-3-[(2-aminoethyl)amino]propanesulfone, sodium-2-[(2-aminoethyl)amino]ethanesulfonate, or a mixture thereof.

5. The water-dispersible polyurethane-urea resin composition for synthetic leather of claim 1, wherein a mixing ratio of the polyester polyol and the polyether polyol is in a range of 1:0.25 to 2 by weight.

6. The water-dispersible polyurethane-urea resin composition for synthetic leather of claim 1, wherein the polyol comprises one or more of polytetramethylene glycol, polyethylene glycol, polypropylene glycol, polyoxypropylene ether glycol, polyethylene butylene adipate glycol, polyethylene adipate glycol, polybutylene adipate glycol, polyhexamethylene adipate glycol and polycaprolactone glycol.

7. The water-dispersible polyurethane-urea resin composition for synthetic leather of claim 1, wherein the isocyanate comprises an aliphatic isocyanate, an aromatic isocyanate or a mixture thereof.

8. The water-dispersible polyurethane-urea resin composition for synthetic leather of claim 7, wherein a mixing ratio of the aliphatic isocyanate and the aromatic isocyanate is in a range of 1:0.5 to 2 by weight.

9. The water-dispersible polyurethane-urea resin composition for synthetic leather of claim 1, wherein the isocyanate comprises one or more of dicyclohexylmethane diisocyanate, isophorone diisocyanate, 1,6-hexamethylene diisocyanate, 2,4-toluene diisocyanate, 2,6-toluene diisocyanate, 4,4′-diphenylmethane diisocyanate, 1,5-naphthalene diisocyanate, p-phenylene diisocyanate, and m-phenylene diisocyanate.

10. The water-dispersible polyurethane-urea resin composition for synthetic leather of claim 1, comprising: with respect to the total weight of the polyol,
the isocyanate in an amount ranging from 20 to 70 parts by weight; and
the ionic compound comprising the sulfonic acid group in an amount ranging from 1 to 15 parts by weight.

11. The water-dispersible polyurethane-urea resin composition for synthetic leather of claim 1, wherein layer separation phenomenon does not occur when the water-dispersible polyurethane-urea resin composition for synthetic leather is stored at 70° C. for 14 days or more.

12. A method of preparing a water-dispersible polyurethane-urea resin composition for synthetic leather, the method comprising:
preparing a prepolymer by reacting a polyol comprising a polyester polyol, a polyether polyol, or a mixture thereof with an isocyanate;
preparing a composition by adding a polar solvent to the prepolymer and then adding an ionic compound comprising a sulfonic acid group; and
adding water to the composition to disperse the composition and then mixing a chain extender thereto.

13. The method of claim 12, wherein a size of polyurethane-urea particles dispersed in the water is in a range of 500 to 1500 nm.
